(19) United States
(12) Patent Application Publication
(10) Pub. No.: US 2026/0015038 A1
(43) Pub. Date: Jan. 15, 2026

(54) METHODS AND APPARATUS TO PROVIDE AUXILIARY STEERING IN A VEHICLE

(71) Applicant: Ford Global Technologies, LLC, Dearborn, MI (US)

(72) Inventors: Sergio Codonesu, Aachen (DE); Alexander Ein Waldt, Köln (DE); Oliver Nehls, Düsseldorf (DE); Goetz-Philipp Wegner, Dortmund (DE)

(21) Appl. No.: 19/179,817

(22) Filed: Apr. 15, 2025

(30) Foreign Application Priority Data
Apr. 17, 2024 (DE) 102024110819.3

(51) Int. Cl. B62D 9/00; B62D 7/15

(52) U.S. Cl. CPC B62D 9/005; B62D 7/159

(57) ABSTRACT

Disclosed examples include detecting a limited operating condition in an electronic steering system of a vehicle, the vehicle including front axle steering and rear axle steering; determining which of the front axle steering or the rear axle steering is associated with the limited operating condition; activating an auxiliary steering system based on at least one of drive units or deceleration devices corresponding to the one of the front axle steering or the rear axle steering associated with the limited operating condition to implement lateral control of the vehicle based on torque control via different wheel-specific torques of the at least one of the drive units or the deceleration devices; measuring a steering angle of a road wheel via a sensor of the auxiliary steering system; and providing the measured steering angle to a control device of the auxiliary steering system.

### RELATED APPLICATION

This patent claims priority from DE Patent Application Number 102024110819.3, which was filed on Apr. 17, 2024, and is hereby incorporated herein by reference in its entirety.

### FIELD OF THE DISCLOSURE

The disclosure relates in general to a method for operating a vehicle having auxiliary steering and to auxiliary steering for a vehicle

### BACKGROUND

Electronic steering systems are an emergent steering technology in which the mechanical connection between steering wheel and road wheel is omitted and replaced by two actuators: an actuator which generates a torque for feedback to the driver (at the steering wheel) and a road wheel actuator which adjusts the road wheels to the desired position.

### SUMMARY

An example method includes detecting an limited operating condition in an electronic steering system of a vehicle, the vehicle including front axle steering and rear axle steering, determining which of the front axle steering or the rear axle steering is associated with the limited operating condition, activating an auxiliary steering system based on at least one of drive units or deceleration devices corresponding to the one of the front axle steering or the rear axle steering associated with the limited operating condition to implement lateral control of the vehicle based on torque control via different wheel-specific torques of the at least one of the drive units or the deceleration devices, measuring a steering angle of a road wheel via a sensor of the auxiliary steering system, and providing the measured steering angle to a control device of the auxiliary steering system.

An example auxiliary steering system for a vehicle includes a control device, and at least one sensor associated with at least one of a plurality of road wheels of the vehicle and configured to record an angular position of the at least one road wheel and to forward the angular position to the control device, the control device to activate the auxiliary steering system in response to a limited operating condition in one of front axle steering or rear axle steering of the vehicle, and provide lateral control of the vehicle based on torque control and the angular position of the at least one road wheel by sending actuating signals to at least one of drive units or deceleration devices corresponding to the one of the front axle steering or the rear axle steering associated with the limited operating condition, the actuating signals to cause generation of wheel-specific torques at corresponding ones of the road wheels of the vehicle.

An example non-transitory machine-readable storage medium includes instructions to cause programmable circuitry to at least obtain an angular position of a road wheel of a vehicle based on a measurement from a sensor, activate an auxiliary steering system in response to a limited operating condition associated with one of front axle steering or rear axle steering of the vehicle, and implement lateral control of the vehicle based on torque control and the angular position of the road wheel by generating an actuating signal to control at least one of a drive unit or a deceleration device corresponding to the one of the front axle steering or the rear axle steering associated with the limited operating condition, the actuating signal to cause generation of a wheel-specific torque at the road wheel.

### BRIEF DESCRIPTION OF THE DRAWINGS

FIG. 1 shows a vehicle having auxiliary steering and an electronic steering system according to examples disclosed herein.

FIGS. 2 to 5 show an example additional sensor in association with the auxiliary steering according to examples disclosed herein.

FIG. 6 is a flowchart representative of example machine-readable instructions and/or example operations that may be executed, instantiated, and/or performed by example programmable circuitry to operate a vehicle having auxiliary steering and an electronic steering system in accordance with examples disclosed herein.

FIG. 7 is a block diagram of an example processing platform including programmable circuitry structured to execute, instantiate, and/or perform the example machine readable instructions and/or perform the example operations of FIG. 6 to implement examples disclosed herein.

In general, the same reference numbers will be used throughout the drawing(s) and accompanying written description to refer to the same or like parts. The figures are not necessarily to scale.

### DETAILED DESCRIPTION

Since an unexpected operating condition (e.g., a limited operating condition) in an electronic steering system of a vehicle could lead to a loss of steerability, examples disclosed herein may be used to implement a steering system configured with sufficient redundancy to substantially ensure that the vehicle may always be brought into a desired state such as, for example, driving at very low speed (“crawling speed”).

Following an initial unexpected operating condition, an electronic steering system that only provides one redundancy level could rapidly force the vehicle into a crawling state (e.g., within a few minutes or even more quickly), thereby reducing the functionality of the vehicle. In addition, this transition represents a significant system change for the driver in terms of vehicle control. For example, it may result in an automatic reduction in the speed of the vehicle or even a stop. Therefore, examples disclosed herein provide additional redundancies so that the vehicle may at least still be operated.

One option of adding redundancy to lateral control of a vehicle includes using other vehicle actuators, such as drive units (e.g., motors) and/or deceleration devices (e.g., wheel brakes), which may bring about wheel-specific torques. Lateral control of the vehicle may be enabled via different torques controlled by the drive units and/or deceleration devices (so-called tertiary lateral control or TLC), referred to below as auxiliary steering.

It is known to use this redundancy if the conventional steering system can no longer offer sufficient lateral control, for example in the event of total inoperability of the electronic steering system (see DE 10 2022 103 808 A1, DE 10 2018 212 804 A1 and DE 10 2019 129 032 A1). It is additionally known to adapt the functionality of a steering system as a consequence of recording an unexpected operating condition (see U.S. Pat. No. 11,318,962 B2 and U.S. Pat. No. 11,780,493 B2).

The auxiliary steering can be based on information relating to the steering wheel angle (e.g., the steering angle input from the driver) to ascertain the desired direction of the vehicle. Conventionally, auxiliary steering can also use information relating to the actual wheel angle to adjust the road wheels to the desired position to comply with the driver input. According to previous approaches, it is known to obtain the information relating to the actual wheel angle through measurements with the aid of components of the conventional steering system of the vehicle. The information may also be used if the conventional electronic steering system has an unexpected operating condition (e.g., a limited operating condition). As a result, situations may arise in which the conventional electronic steering system may no longer provide the information such as, for example, because the unexpected operating condition is associated with the measurement of the wheel angle or because a control device is in an unexpected operating state (e.g., a limited operating state). If the information is provided by the conventional electronic steering system, it may be unclear whether the information is reliable in the event of an unexpected operating condition.

In one alternative, the information may also be obtained through estimation with the aid of vehicle data, such as wheel speeds, yaw rates and the like. In this case, however, relatively complex estimation procedures are needed, whereby the information is slowed down and is only imprecisely available—for example in the case of significant wheel slip, which typically occurs when using auxiliary steering. Consequently, the precision of lateral control of the vehicle is restricted. Moreover, the complexity of the estimation procedure is high, making the system complicated and costly.

Examples disclosed herein overcome, or at least reduce, the disadvantages of known methods and auxiliary steering systems. Examples disclosed herein provide a method and an auxiliary steering system in which, in the event of an unexpected operating condition (e.g., a limited operating condition) in the electronic steering system of the vehicle, the precision of the lateral control of the vehicle is increased over that of previous approaches.

Some disclosed examples relate to methods of operating a vehicle having auxiliary steering. The vehicle has one or more drive units (e.g., motors) and/or deceleration devices (e.g., wheel brakes), which are associated with respective road wheels of the vehicle. Some disclosed methods include at least the following:

An unexpected operating condition (e.g., a limited operating condition) in an electronic steering system of the vehicle is detected. In examples disclosed herein, unexpected operating condition, limited operating condition, unexpected operating state, and limited operating state may be used interchangeably to refer to a condition or a state of a component that is unavailable, inoperable, and/or operating outside of an operating specification performance range of the component.

An auxiliary steering system, based on one or more drive units and/or deceleration devices, is activated. The auxiliary steering system has a control device, which implements lateral control of the vehicle with the aid of torque control (also referred to as torque vectorization via tertiary lateral control, e.g., TLC) via different wheel-specific torques of the multiple drive units and/or deceleration devices.

At least one steering angle of a road wheel or a corresponding measured variable is recorded (e.g., acquired) via at least one additional sensor (e.g., a supplemental sensor) of the auxiliary steering system. The additional sensor is associated with the road wheel and forwards the recorded steering angle or the corresponding measured variable to the control device of the auxiliary steering system.

As a result, the wheel-specific torque control, which is executed by the auxiliary steering system to enable vehicle lateral control, may advantageously take place independently of the conventional, electronic steering system of the vehicle. The information relating to the steering angle of the at least one road wheel may be recorded by the additional sensor, independently of the conventional, electronic steering system. As a result, the need for estimation procedures to estimate the information relating to the steering angle may be substantially reduced or eliminated. As a result, the precision of the lateral control of the vehicle with the aid of the wheel-specific torque control may be substantially high because, for example, the direct recording of the steering angle with the aid of the additional sensor results in increased precision and shorter recording intervals of the measurement signal than would be the case if using an estimation procedure. Furthermore, the information relating to the steering angle of the road wheel, which is recorded by the additional sensor, is also credible in the sense that it is not corrupted or generally influenced by the unexpected operating condition in the conventional, electronic steering system.

In examples disclosed herein, vehicle lateral control is enabled with high precision and low complexity because it is possible to dispense with complex estimation procedures.

According to a further aspect, some examples disclosed herein also relate to auxiliary steering systems for vehicles. A vehicle comprises multiple road wheels and one or more drive units and/or deceleration devices. The one or more drive units and/or deceleration devices are each associated with at least one road wheel and are configured to apply a respective wheel-specific torque to at least one road wheel. An auxiliary steering system comprises a control device and at least one additional sensor. The additional sensor is associated with a road wheel and is configured to record an angular position (referred to as toe angle, also wheel angle) of the road wheel or a corresponding measured variable and to forward it to the control device of the auxiliary steering system. The control device is configured to activate the auxiliary steering system in the event of an unexpected operating condition in the electronic steering system of the vehicle and to bring about lateral control based on torque control. The torque control is configured in such a way that actuating signals can be output to the one or more drive units (e.g., phase voltages) and/or deceleration devices, so that they output a wheel-specific torque to the road wheels respectively associated therewith.

The advantages achieved by examples disclosed herein are likewise achieved in a corresponding manner by the auxiliary steering system.

The electronic steering system may be understood to be a steer-by-wire (SbW) steering system.

The electronic steering system of the vehicle here is understood to be the conventional electronic steering system of the vehicle and not the auxiliary steering system implemented via the torque control in respect of the drive units and/or deceleration devices associated with respective road wheels (e.g., not the TLC).

The lateral control of the vehicle may be optionally based on steering inputs from the driver, which are provided by the driver, for example with the aid of the steering wheel, to steer the vehicle in a specific direction.

In the present case, the drive units are understood to be correspondingly operated electric motors, which are each associated with at least one road wheel and serve for driving the vehicle.

An unexpected operating condition in the electronic steering system may be caused, for example, by an unexpected operating state (e.g., a limited operating state) of a steering system component (e.g., a wheel actuator), which is detected or established, for example, by a sensor of the electronic steering system. An unexpected operating condition here does not necessarily relate to complete inoperability. The unexpected operating condition in the electronic steering system may also be manifested in the electronic steering system as decreased functionality. For example, as a result of an unexpected operating condition (e.g., in the control device), the electronic steering system may no longer be capable of adequately converting steering inputs, which are provided by the driver using the steering wheel, into altered wheel angles (referred to as toe angles, also wheel orientations). Unexpected operating conditions may also additionally occur in that functions executed by steering system components of the electronic steering system are outside a defined normal range. For example, it may be that sensors, as steering system components, forward measured values within a defined range to the control device. However, if a forwarded measured value is outside the range, it may be assumed that there is an issue (e.g., an unexpected operating condition) with the sensor (e.g., a steering system component). As a result, steering system components which are still operational, albeit in an unexpected operating state (e.g., a limited operating state), may be recorded, which ultimately provide an explanation for the unexpected operating condition of the electronic steering system.

In some examples, the conventional, electronic steering system can no longer be reliably used to adequately and reliably ensure vehicle lateral control. This should be distinguished from vehicle lateral control which is inadequate due to external conditions such as, for example, in the event of significant wheel slip caused by icy roads. In this sense, the conventional, electronic system may have a control device which establishes an unexpected operating condition and, as a consequence of recording the unexpected operating condition or ascertaining that an unexpected operating condition exists, the control device instructs the auxiliary steering system to continue methods as described herein (e.g., activation of the auxiliary steering system).

In some examples, the unexpected operating condition in the electronic steering system may also be recorded by a superordinate driving control device (e.g., a separate electronic control unit (ECU) external from the electronic steering system) of the vehicle, which executes test functions in respect of the functionality of the electronic steering system. The driving control device may also act as a control device for the auxiliary steering system, as will be explained in more detail below.

An auxiliary steering system is understood to be a system which enables vehicle lateral control indirectly, namely via different wheel-specific torques output to the respective road wheels. This leads to a resultant force on the steering rod at the front axle owing to the front axle geometry (lever arms). Accordingly, different rotational speeds of the road wheels of the front axle are generated to set a toe angle. Such toe angle may, therefore, be adjusted according to the driver input via the auxiliary steering system. Alternatively or additionally, a yaw moment may likewise be set via the rear axle with corresponding independently controlled wheel-specific torques, which provokes a vehicle reaction corresponding to the driver input.

Typically, for vehicle lateral control, at least multiple actuating inputs with regard to different road wheels are needed to bring about wheel-specific torques, so that a change in the steering angle of the recorded road wheel and/or a vehicle yaw moment may be induced.

In examples disclosed herein, the additional sensor is understood to be a sensor which is not part of the conventional electronic steering system. It refers to a sensor outside and separate from the electronic steering system, which is independent thereof. The additional sensor may be coupled to components of the electronic steering system (e.g., mechanically coupled) depending on the positioning of the additional sensor. However, the additional sensor is such that it does not correspond to the sensor of the electronic steering system that conventionally records the steering angle (referred to as toe angle, also wheel angle) of a road wheel and forwards it to a control device of the electronic steering system. The additional sensor is separate from the electronic steering system in the sense that its functionality does not depend on actuating signals or control signals which are forwarded by a control device of the electronic steering system. The additional sensor is also not coupled to a control device of the conventional electronic steering system. Consequently, in the event of an unexpected operating condition in the electronic steering system, the additional sensor is prevented from being corrupted by the unexpected operating condition in the electronic steering system.

The vehicle is advantageously configured in such a way that a power supply to the additional sensor is ensured separately from the electronic steering system. For example, the additional sensor may be coupled to an electrical supply circuit which does not depend on the functionality of the electronic steering system.

For wheel-specific torque control of the auxiliary steering system, the auxiliary steering system can take into account simplifications or generalizations such as, for example, assumptions to the effect that the front or rear road wheels of the vehicle are orientated in a corresponding manner in pairs. For example, road wheels on the inside of a curve generally have different steering angles (e.g., wheel angles) owing to the different curve trajectory in relation to the road wheel on the outside of the curve. However, depending on the vehicle speed and the wheel slip, which may, for example, be ascertained via sensors (e.g., the additional sensor), the difference in the steering angles of the road wheels is already known. It may, therefore, be sufficient to provide a single additional sensor for the auxiliary steering system. Ultimately, from the steering angle recorded via the at least one additional sensor, it is possible to estimate the steering angle of the other road wheels. As a result, the method is particularly compact.

Multiple additional sensors may optionally be provided, which are configured independently of one another to record steering angles (toe angle, wheel angle) of road wheels with which they are associated. The multiple additional sensors may forward the recorded steering angles to the control device of the auxiliary steering system. Therefore, the precision of the auxiliary steering system may be further increased because the steering angles of the different road wheels may be recorded and taken into account in the torque control.

In examples disclosed herein, a deceleration device is understood to be a device which is associated with a road wheel and which is configured to reduce a rotational speed of the road wheel such as, for example, through frictional contact with a friction disk.

In some examples, the additional sensor is configured to record a relative angular position or an absolute angular position of the road wheel and to forward the relative angular position or the absolute angular position to the control device of the auxiliary steering system. The absolute angular position of the road wheel differs from the relative angular position of the road wheel in that, in regard to the absolute angular position, a reference value is already known, for example a zero position of the road wheel or a straight-ahead position of the road wheel corresponding to the conventional vehicle straight-ahead direction. However, recording the relative angular position may generally be sufficient if, for example, the control device of the auxiliary steering system includes a reference value for the respective road wheel based on the measurement data obtained from the additional sensor. A respective reference value may be stored in, for example, a memory device that is coupled to the control device of the auxiliary steering system.

In such examples, the recording of at least one steering angle of a road wheel via the additional sensor of the auxiliary steering system is also understood to refer to the indirect recording thereof. This means that the additional sensor may be configured to provide measured values for the control device of the auxiliary steering system so that the measured values can be used to indirectly ascertain the steering angle of the road wheel or the road wheels. In such examples, the recording of the steering angle is not limited to the effect that the additional sensor has to record the steering angle directly. Instead, the additional sensor may also record an orientation, position or distance or other measured variable in general, which enables the ascertainment of the steering angle since it corresponds to the steering angle.

In some examples, the control device takes into account a reference angle value for the road wheel. In such examples, the additional sensor is configured to record (e.g., acquire) a relative angular position of the road wheel that is respectively associated therewith. As such, the recording of the measured value need not increase the complexity of the additional sensor.

In some examples, the electronic steering system of the vehicle comprises front axle steering and rear axle steering. The unexpected operating condition in the electronic steering system is then detected in relation to either the front axle steering or rear axle steering. The auxiliary steering system is then additionally activated based on which of the front axle steering and rear axle steering is not associated with (e.g., operating without) an unexpected operating condition. In such examples, the control device implements lateral control of the vehicle, at least also based on which of the front axle steering and rear axle steering is not associated with (e.g., operating without) an unexpected operating condition. As such, the precision in the lateral control of the vehicle may be further increased. A determination of which of the front axle steering and rear axle steering is in an unexpected operating state may also be taken into account to bring about desired lateral control in combination with wheel-specific torques, which the auxiliary steering system generates via corresponding drive units and/or deceleration units at the road wheels of the front axle steering or rear axle steering associated with the unexpected operating condition.

Alternatively, the auxiliary steering system may also be implemented exclusively via rear axle steering (e.g., if the front axle steering is associated with an unexpected operating condition). A rear axle toe angle is set by the auxiliary steering system in examples disclosed herein, taking into account the current front axle angle, which in turn also generates a vehicle reaction (e.g., vehicle lateral control) corresponding to the driver input.

In some examples, the additional sensor is configured to be selectively coupled to different electrical supply circuits. For example, the additional sensor may have a power switch, which, depending on its switching position, enables the additional sensor to be coupled to different electrical supply circuits. As a result, a redundancy of the power supply to the additional sensor may be created so that the availability of the example methods and the example auxiliary steering systems disclosed herein is increased.

The additional sensor may be configured in such a way that there is an automatic switch from a first electrical supply circuit to supply power to the additional sensor to a second electrical supply circuit if the power supply via the first electrical supply circuit is no longer available. For example, the additional sensor may also comprise a voltage sensor, which is configured to record supply voltages. Depending on the supply voltages recorded by the voltage sensor, the power switch may be switched in order to bring about coupling to a specific electrical supply circuit.

In some examples, the additional sensor has a sensor element, a sensor logic circuit, a communication interface and a supply connection. With the aid of the supply connection, the additional sensor may be coupled to an electrical supply circuit for power supply purposes. The communication interface enables communication between the additional sensor and external devices such as, for example, the control device of the auxiliary steering system. The sensor logic circuit enables the interpretation of the measurement data recorded by the additional sensor with the aid of the sensor element in order to output corresponding measurement data or measured values to an external device such as, for example, the control device of the auxiliary steering system. The sensor element enables the recording of measured values such as, for example, measured values of a component coupled thereto. The sensor element may be configured in a variety of ways including, for example, as a magnetically based sensor element or electrically based sensor element that is configured to record a change in orientation or a change in position of an external component (e.g., a mechanical component).

In some examples, the sensor element is configured as a magnetic ring or magnetic coil in which a voltage is induced depending on a change in position or movement (e.g., a change in angle) of the recorded external component such as, for example, the road wheel.

In some examples, the additional sensor is implemented as a pinion sensor. In such examples, the additional sensor may be implemented using any suitable type of sensor. The pinion sensor may have two different gears which, for example, enable the rotational position of at least one pinion to be ascertained.

In other examples, the additional sensor is implemented as a Hall effect sensor. In such examples, using a Hall effect sensor may increase the compatibility of example methods disclosed herein.

In some examples, the additional sensor may be implemented as a pinion sensor and coupled to a pinion tower. In such examples, the additional sensor is configured to record the pinion angle.

Alternatively, the additional sensor may be implemented as a linear sensor, which is coupled to a steering rack. In such examples, the additional sensor is configured to record a steering rack travel.

In a further alternative, the additional sensor is implemented as a rotation sensor and is coupled to a ball screw nut. In such examples, the additional sensor is configured to record a rotational speed of the ball screw nut.

Of course, various similar and/or different additional sensors may be optionally part of the electronic steering system. As a result, the redundancy of the electronic steering system is increased. As such, the steering angle (wheel angle, toe angle) of a road wheel may be reliably recorded, at least indirectly with the aid of a measured variable corresponding to the steering angle.

The control device of the auxiliary steering system may be configured to ascertain or at least estimate an absolute angular position of the road wheel, for which measured values are forwarded from the additional sensor. For example, there is a fixed association between the position of a steering rack of the electronic steering system and the steering angles of the road wheels coupled to the steering rack. This association may be used by the control device of the auxiliary steering system to ascertain the steering angle of at least one road wheel, or more or all road wheels, of the vehicle.

A mechanical part of the additional sensor may also be a physical part of the electronic steering system. This means that the sensor element may be integrated in the electronic steering system. The integration may be the coupling of the additional sensor to a mechanical component of the electronic steering system. The additional sensor is otherwise independent of the electronic steering system. This means that at least the sensor logic circuit, the communication interface and the supply connection are independent of the electronic steering system and, therefore, the additional sensor also cannot be influenced by an unexpected operating condition in the electronic steering system. In particular, the additional sensor cannot be influenced by unexpected operating conditions in control, unavailability or inoperability of a power supply of the electronic steering system or unexpected system operating states in a control device of the electronic system, since the sensor logic circuit and the power supply are independent of the electronic steering system. It is, therefore, impossible for an unexpected operating condition in the electronic steering system to propagate into the auxiliary steering system.

In some examples, the additional sensor can be coupled to a driving control device of the vehicle. The driving control device controls the drive units and/or deceleration devices for driving the vehicle. In such examples, the driving control device of the vehicle also executes the functionality of the control device of the auxiliary steering system. For example, the driving control device may generally be a control device which converts speed inputs from the driver of the vehicle into torque inputs, which are output to corresponding drive units and/or deceleration devices with the aid of actuating signals for the purpose of driving the vehicle. In such examples, a separate control device of the auxiliary steering system can be omitted because the functionality of such a separate control device is implemented in the driving control device. The auxiliary steering system and the vehicle are, therefore, particularly compact or space-efficient. The driving control device may also be configured to monitor the electronic steering system such as monitoring functionality and the occurrence of unexpected operating conditions in the electronic steering system. As such, the vehicle may be particularly compact (e.g., space-efficient) and the method may not require any additional circuits, for example, with the exception of the additional sensor.

The ascertainment of positional information of an external (e.g., mechanical) component recorded by the additional sensor may take place either within the additional sensor in, for example, the sensor logic circuit, or with the aid of an external data processing device of, for example, the driving control device. The evaluations may comprise both the diagnosis for ensuring the required integrity (also referred to as Automotive Safety Integrity Level (ASIL)) and the calculations of relative and/or absolute information in respect of the angular position of the road wheel.

In some examples, the additional sensor may be coupled to a vehicle bus such as, for example, a controller area network (CAN) bus, Flexray, Ethernet or a single edge nibble transmission (SENT) bus, via an external control device such as, for example, the driving control device. As such, the compatibility of examples disclosed herein is increased because additional communication paths and protocols for communication with further vehicle components are enabled.

Examples disclosed herein may be implemented as computer-implemented methods. This means that operations of examples disclosed herein may be executed with the use of one or more data processing devices. For example, the detection of an unexpected operating condition in the electronic steering system, the activation of the auxiliary steering system and the recording of at least one wheel angle may be performed via a data processing device supplemented by one or more other data processing devices.

According to a further aspect, the disclosure also relates to a computer program product, comprising machine-readable instructions which, when the machine-readable instructions are executed by a computer, prompt this latter to execute example methods as described herein. The advantages achieved by the example methods described herein are also achieved in a corresponding manner by the computer program product.

According to an additional aspect, the disclosure also relates to a computer-readable storage medium, comprising machine-readable instructions which, when the machine-readable instructions are executed by a computer, prompt this latter to execute the example methods as described herein. The advantages achieved by the example methods described herein are also achieved in a corresponding manner by the computer-readable storage medium.

According to an additional aspect, some examples of the disclosure also relate to a vehicle having an auxiliary steering system. The advantages achieved by examples described herein are also achieved in a corresponding manner by the vehicle.

Within the context of the disclosure, vehicles may include, for example, land vehicles; namely, inter alia, off-road vehicles and road vehicles such as automobiles, buses, trucks and other utility vehicles. Vehicles may be manned or unmanned. Vehicles may be at least sometimes driven electrically and may have an internal combustion engine and/or an electric motor serving as the drive.

All of the features explained with regard to the various aspects can be combined with other aspects individually or in (sub) combinations.

The disclosure and further advantageous examples and developments thereof are described and explained in more detail below relative to examples illustrated in the drawings.

The description detailed below, in conjunction with the accompanying drawings in which the same numerals refer to the same elements, is intended to describe various examples of the disclosed subject matter and shall not merely represent the individual examples. Each example described in this disclosure serves merely as an example or illustration and should not be interpreted as preferred or advantageous over other examples. The illustrative examples contained herein make no claim to completeness and do not limit the claimed subject matter to the exact forms disclosed. Various modifications of the described examples and the general principles defined herein may be applied to other examples and applications without deviating from the spirit and scope of the examples described. The described examples are, therefore, not limited to the examples shown but have the greatest possible range of applications compatible with the principles and features disclosed herein.

All features disclosed below with respect to the described examples and/or the accompanying figures may be combined with features of the aspects of the disclosure individually or in any sub-combination.

For the purposes of the disclosure, the formulation “at least one of A, B and C” means, for example, (A), (B), (C), (A and B), (A and C), (B and C) or (A, B and C), including all further possible combinations, if more than three elements are listed. In other words, the wording “at least one of A and B” means, in general, “A and/or B”, namely “A” alone, “B” alone or “A and B”.

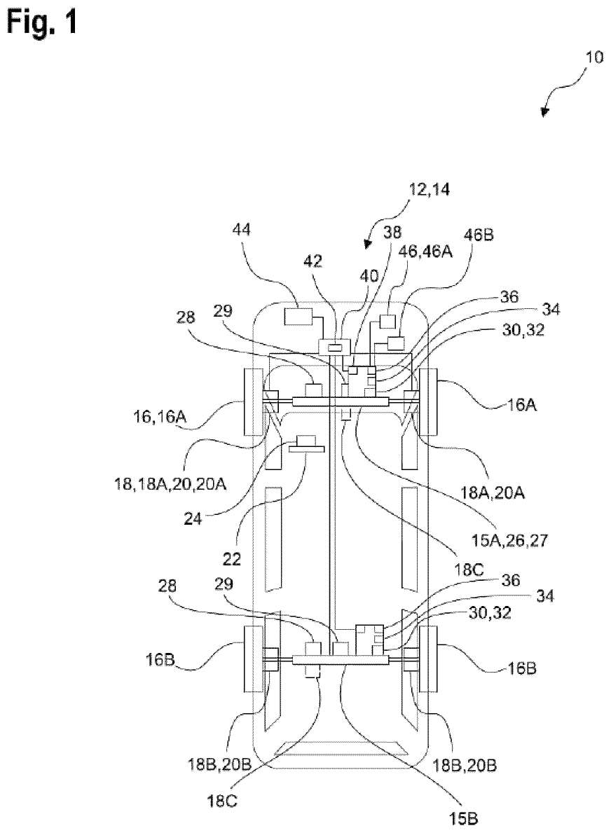

FIG. 1 shows a vehicle 10 having an auxiliary steering system 12 according to examples disclosed herein.

The vehicle 10 has the auxiliary steering system 12 and an electronic steering system 14. In examples disclosed herein, the electronic steering system 14 corresponds to a conventional steering system normally used for lateral control of the vehicle 10.

According to the example of FIG. 1, the vehicle 10 comprises front axle steering 15A and rear axle steering 15B, which are both configured for lateral control of the vehicle 10.

The vehicle 10 comprises road wheels 16, 16A, 16B. According to the example of FIG. 1, both the front road wheels 16A and the rear road wheels 16B are steerable. This means that the orientation of the front and rear road wheels 16A, 16B can be changed in order to enable vehicle lateral control with, for example, the aid of the electronic steering system 14.

In other words, lateral control of the vehicle 10 may be brought about using the front road wheels 16A and/or the rear road wheels 16B, by setting the steering angles (e.g., wheel angle, toe angle) of the road wheels either wheel-specifically or such that they are respectively coupled or all coupled.

According to the example of FIG. 1, drive units 18, 18A, 18B are associated with the road wheels 16. In the example of FIG. 1, one drive unit 18 is associated with a corresponding road wheel 16. The drive units 18 are configured to apply torques to corresponding ones of the road wheels 16 to drive the vehicle 10.

In the example of FIG. 1, respective deceleration devices 20, 20A, 20B are also associated with the road wheels 16. In the example of FIG. 1, one deceleration device 20 is associated with one road wheel 16. The deceleration devices 20 are configured to apply torques to corresponding ones of the road wheels 16 to reduce the speed of the vehicle 10.

Alternatively, corresponding drive units 18 and/or deceleration devices 20 may be associated with only specific road wheels 16.

In some examples, for driving purposes, only a single drive unit 18C generally needs to be provided for each front axle or rear axle of the vehicle 10. In such examples, such drive unit drives the road wheels 16 of the respective vehicle axle.

Alternatively or additionally, the drive units 18 may also be used to reduce the speed of the vehicle 10 while also recovering electric energy.

The vehicle 10 also comprises a steering wheel 22 through which a driver of the vehicle 10 may provide steering inputs for lateral control of the vehicle 10. To record the steering inputs from the driver of the vehicle 10, the vehicle 10 has a steering actuator 24 with feedback.

The steerable road wheels 16 of a vehicle axle of the vehicle 10 are coupled to one another via a mechanical component 26 such as a steering rack 27 in the illustrated example. The steering rack 27 enables a corresponding deflection of the road wheels 16 relative to a reference direction of the road wheels 16. In examples disclosed herein, the reference direction of the road wheels 16 is defined by a straight-ahead direction of the vehicle 10, which corresponds to a zero alignment of a steering angle of the road wheels 16 in the illustrated example.

The electronic steering system 14 has a redundant steering actuator 28 for each steering rack, which is coupled to the steering rack 27. The redundant steering actuator 28 is configured to move the steering rack 27, starting from a zero position, to create a deflection of the road wheels 16 relative to the reference direction.

Although steering actuators 28 are illustrated in FIG. 1 relative to steering racks 27 of both vehicle axles of the vehicle 10, the vehicle 10 generally only needs to have a single steering rack 27 (e.g., exclusively on the front axle steering 15A). For example, this may be the case in vehicles 10 without rear axle steering 15B.

The electronic steering system 14 also has at least one sensor 29, which is used for the functionality of the redundant steering actuator 28 and which provides the electronic steering system 14 with feedback relating to the position of the steering rack 27. For example, two mutually redundant sensors 29 may be provided. For example, the redundant steering actuator 28 may have multiple sensors 29. As such, the electronic steering system 14 may control the alignment of the road wheels 16 in such a way that the steering inputs provided by a driver of the vehicle 10 with the aid of the steering wheel 22 are converted into a lateral control of the vehicle 10 (e.g., a rotation of the vehicle 10 about the vehicle vertical axis). Via the at least one sensor 29 of the electronic steering system 14, examples disclosed herein can check whether the functionality of the electronic steering system 14 is operating as intended to comply with setpoint inputs provided via the steering wheel 22.

In alternative examples, the electronic steering system 14 may also have at least two steering actuators 28, which set the steering angle (e.g., wheel angle, toe angle) of a road wheel 16 on a per-wheel basis. In such examples, sensors 29 may also be provided and configured so that the steering angles of the different road wheels 16 are recorded.

In comparison with the at least one sensor 29 of the electronic steering system 14, the auxiliary steering system 12 has an additional sensor 30. The additional sensor 30 is separate from the sensor 29 (multiple sensors in some examples) of the electronic steering system 14. During the operation of the electronic steering system 14, the additional sensor 30 is not used by the electronic steering system 14 to control the electronic steering system 14.

In the illustrated example, the additional sensor 30 is likewise coupled to the same mechanical component 26 (e.g., the steering rack 27). Generally, however, the additional sensor 30 may also be coupled to other mechanical components 26 which enable a steering angle of the steerable road wheels 16 of the vehicle 10 to be recorded or enable measured values to be recorded, which correspond to the steering angle and from which the steering angle can therefore be ascertained.

The additional sensor 30 has a sensor element 32, a sensor logic circuit 34, a supply connection 36 and a communication interface 38. The sensor element 32 enables the recording of measured values corresponding to the external mechanical component 26, such as the steering rack 27 of FIG. 1, coupled to the additional sensor 30. The sensor element 32 is configured to record a change in position or the movement of the external mechanical component 26, such as a steering rack travel of the steering rack 27 relative to a reference position (e.g., zero position). The sensor logic circuit 34 is configured to interpret the measured values recorded by the sensor element 32 and to provide them for other components of the auxiliary steering system 12. The supply connection 36 is configured to enable coupling to an external switching circuit to connect a power supply to the additional sensor 30. The communication interface 38 is configured to enable communication with external components of the vehicle 10.

In the illustrated example, the vehicle 10 comprises a control device 40 (e.g., an ECU), which is part of the auxiliary steering system 12. The control device 40 has a data processing device 42. In the illustrated example, the control device 40 is additionally coupled to a superordinate driving control device 44 (e.g., a separate ECU external from the auxiliary steering system 12), and bidirectional communication between the superordinate driving control device 44 and the control device 40 of the auxiliary steering system 12 is enabled. In the illustrated example, the superordinate driving control device 44 is not part of the auxiliary steering system 12, although it may be in other examples and may then take over the functionality of the control device 40.

The superordinate driving control device 44 is optionally provided. It may also be omitted.

In the illustrated example, the vehicle 10 additionally comprises multiple energy supply circuits 46, 46A, 46B, which are independent of one another. In the illustrated example, the energy supply connection 36 of the additional sensor 30 is configured to be selectively coupled to multiple energy supply circuits 46 at the same time to supply power to the additional sensor 30. Therefore, only one energy supply circuit 36 is coupled to the additional sensor 30 for power supply purposes. However, since the energy supply connection 36 can be selectively coupled to multiple energy supply circuits 46, a redundancy in respect of the energy supply to the additional sensor 30 may therefore be ensured.

In some examples, the additional sensor 30 may also have an additional sensor element 32, which is redundant to the sensor element 32 illustrated here. Should a first sensor element 32 of the additional sensor 30 be in an unexpected operating state, the recording of measured values then takes place based on the additional sensor element 32.

In the illustrated example, the control device 40 of the auxiliary steering system 12 is coupled to the drive units 18 and the deceleration devices 20 of the vehicle 10. In the illustrated example, the control device 40 of the auxiliary steering system 12 is also additionally coupled to the rear axle steering 15B. The control device 40 of the auxiliary steering system 12 is configured to operate as a tertiary lateral control (TLC) of the vehicle 10. This means that steering inputs provided via the steering wheel 22 may be converted into an indirect lateral control of the vehicle 10 based on different wheel-specific torques determined by the control device 40 of the auxiliary steering system 12. The different torques are generated based on corresponding actuating signals of the control device 40, which are output to the drive units 18 and/or deceleration device 20 which are associated with the different road wheels 16. Based on the corresponding actuating signals of the control device 40, different wheel-specific torques are applied to the road wheels 16 by the drive units 18 and/or deceleration devices 20. This results indirectly in a rotation of the vehicle 10 about the vehicle vertical axis (e.g., due to an induced yaw moment) and, therefore, in lateral control of the vehicle 10.

Alternatively or additionally, the control device 40 of the auxiliary steering system 12 is also configured to provide lateral control of the vehicle 10 with the aid of the rear axle steering 15B based on steering inputs from the driver of the vehicle 10. This means that the road wheels 16 of the rear axle steering 15B can be controlled based on their steering angle provided by the control device 40. To this end, the control device 40 may output corresponding actuating signals to the rear axle steering 15B. This may be used in combination with wheel-specific torques which are applied to the road wheels 16 of the front axle steering 15A.

To ascertain the actuating signals, the control device 40 has torque control with feedback, which is based on the steering inputs via the steering wheel 22 and the measured values, which are recorded using the additional sensor 30. In examples disclosed herein, the control device 40 may be configured in such a way that the actual orientation of the steerable road wheels 16 of the vehicle 10 is ascertained by the control device 40 based on the measured values forwarded by the additional sensor 30.

In one alternative, the additional sensor 30 may also be configured to record the angular position of the steerable road wheels 16 of the vehicle 10 indirectly or ascertain the angular position based on the sensor logic circuit 34 and forwards the angular position ascertained to the control device 40.

In examples disclosed herein, the control device 40 is not based on the recording of measured values based on the at least one sensor 29 of the electronic steering system 14. Only the recording of measured values corresponding to steering inputs provided by the driver via the steering wheel 22 is taken into account and not the measured values which are recorded by the electronic steering system 14 in respect of the steering angle during normal operation. In contrast, the torque control, which is executed by the control device 40 of the auxiliary steering system 12, is based on the recording of measured values based on the additional sensor 30, which is separate from the electronic steering system 14, and is, therefore, independent of the electronic steering system 14. Additionally, the additional sensor 30 is configured to record a measured variable, which is either indirectly equivalent to the steering angle of at least one steerable road wheel 16 of the vehicle 10 or corresponds thereto or which enables the ascertainment thereof. The recorded or ascertained steering angle is then used in the torque control by the control device 40 of the auxiliary steering system 12.

In some examples, multiple additional sensors 30 may be provided, which are associated with respective steerable road wheels 16 of the vehicle 10.

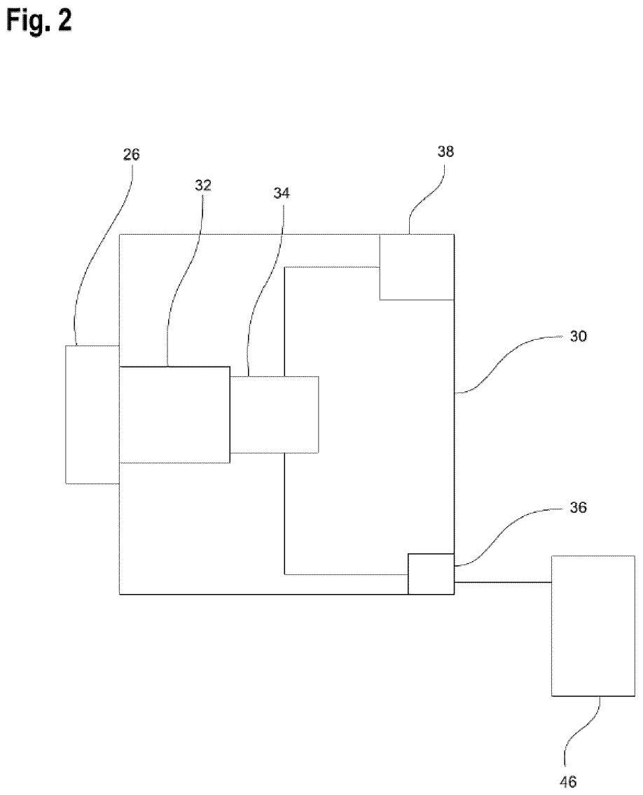

FIGS. 2 to 5 show an example additional sensor 30 in association with the auxiliary steering system 12 according to different examples disclosed herein. Only the respective differences are discussed here.

The sensor element 32 is coupled to the mechanical component 26 and is configured to record a movement or change in position of the mechanical component (FIG. 2). The sensor element 32 may be configured as, for example, a

Hall sensor, a magnetic ring, a magnetic coil, a position sensor or the like. Alternatively, the sensor element 32 may also be configured as a pinion sensor.

The additional sensor 30 may be coupled to different mechanical components 26 such as, for example, to at least one of a pinion tower, a steering actuator of the electronic steering system 14, a steering rack 27 of the electronic steering system 14, or a ball screw nut of the electronic steering system 14.

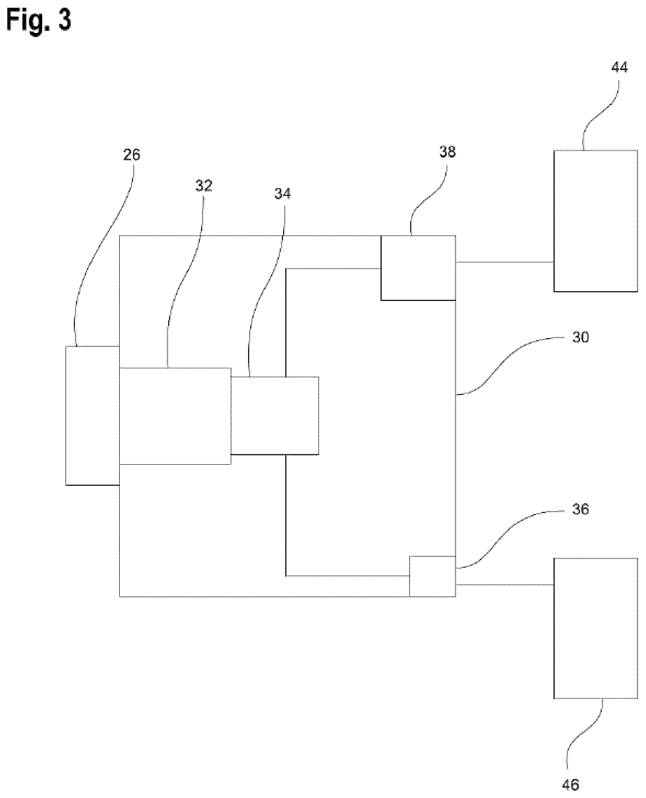

The communication interface 38 is configured to enable bidirectional communication between the additional sensor 30 and an external component such as, for example, the control device 40 of the auxiliary steering system 12. Alternatively, the communication interface 38 of the additional sensor 30 can also be coupled to a superordinate driving control device 44, for example, which unifies the functionality of the control device 40 of the auxiliary steering system 12 (FIG. 3).

The energy supply connection 36 (FIGS. 2 and 3) of the additional sensor 30 is connected to the energy supply circuit 46.

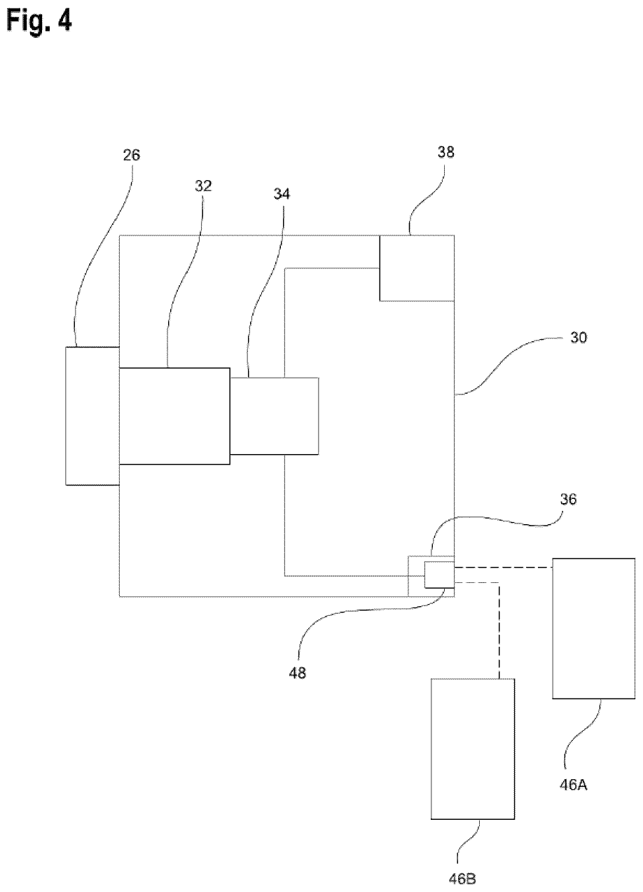

The energy supply connection 36 of the additional sensor 30 may be configured in such a way that it can be coupled to multiple energy supply circuits 46A, 46B of the vehicle 10 for the purpose of supplying energy to the additional sensor 30 (FIG. 4). For this purpose, the energy supply connection 36 may have a power switch 48 which, for example, selectively enables the actual current flow via a specific energy supply circuit 46. Should a specific energy supply circuit 46A no longer be available, the additional sensor 30 may be coupled to another energy supply circuit 46B, depending on the switching position of the power switch 48. The control of the power switch 48 may be executed by, for example, the sensor logic circuit 34 of the additional sensor 30.

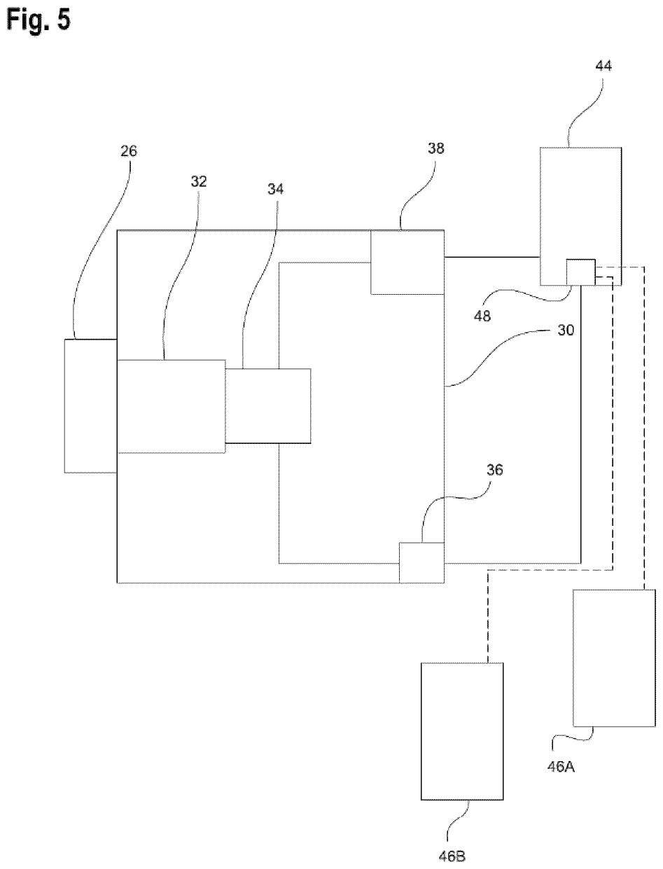

Alternatively, the energy supply to the additional sensor 30 may also be ensured directly by an external control device such as, for example, the superordinate driving control device 44 (FIG. 5). In such examples, the power switch 48 may be implemented directly in the superordinate driving control device 44 for coupling to multiple supply circuits 46. In such examples, the superordinate driving control device 44 also takes over the control of the power switch 48 to selectively couple the additional sensor 30 to a specific energy supply circuit 46 for energy supply purposes. Although the power switch 48 is implemented in a superordinate driving control device 44 in examples disclosed herein, the power switch 48 may, of course, also be alternatively implemented in a control device 40 of the auxiliary steering system 12, which is then separate from a superordinate driving control device 44.

The superordinate driving control device 44 may be configured to execute torque control for the purpose of driving (e.g., the superordinate driving control device 44 is a powertrain system ECU) and/or decelerating (e.g., the superordinate driving control device 44 is a brake system ECU) the vehicle 10 based on drive units 18 and/or the deceleration device 20. This means that the driving functions for the propulsion of the vehicle 10 or the deceleration of the vehicle 10 are already executed by the superordinate driving control device 44. Since the superordinate driving control device 44 may also take over the control functions of the auxiliary steering system 12, the auxiliary steering system 12 then has a particularly compact (e.g., space-efficient) design and requires no additional components apart from the additional sensor 30. As a result, the vehicle 10 is particularly compact.

Alternatively, if the vehicle 10 has rear axle steering 15B, the superordinate driving control device 44 may also execute the control function of the rear axle steering 15.

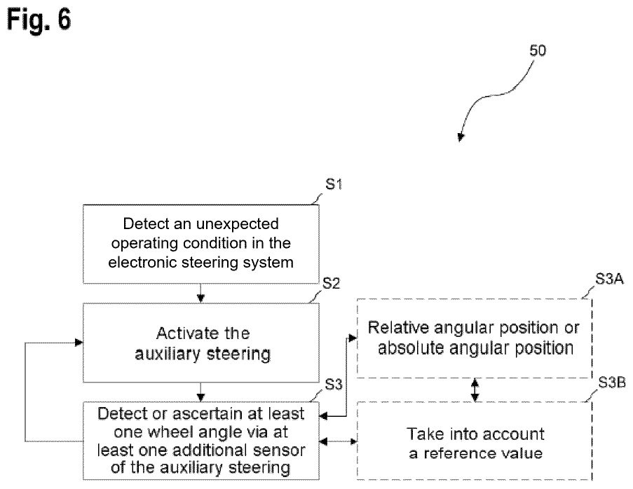

FIG. 6 is a flowchart representative of example machine-readable instructions and/or example operations 50 that may be executed, instantiated, and/or performed by example programmable circuitry to operate a vehicle 10 having an auxiliary steering system 12. Optional instructions and/or operations are illustrated by dashed lines.

In operation S1, an unexpected operating condition in an electronic steering system 14 of the vehicle 10 is detected. This may be established, for example, with the aid of measured values, which are recorded by the at least one sensor 29 of the electronic steering system 14. The superordinate driving control device 44 may optionally execute a monitoring function corresponding to the functionality of the electronic steering system 14 of the vehicle 10. In other words, the superordinate driving control device 44 may be configured to monitor whether the electronic steering system 14 is operating as intended. Alternatively, the unexpected operating state of the functionality of the electronic steering system 14 may also be established by a control device 40 of the electronic steering system 14 itself based on, for example, measured values which are recorded based on the at least one sensor 29.

In operation S2, the auxiliary steering system 12 is then activated based on the multiple drive units 18 and/or deceleration devices 20. The auxiliary steering system 12 disclosed herein has the control device 40 (this may optionally also be the superordinate driving control device 44), which generates steering movements of the vehicle 10 using torque control via different wheel-specific torques of the multiple drive units 18 and/or deceleration devices 20. To this end, the control device 40 outputs corresponding actuating signals to the drive units 18 and/or deceleration devices 20. Based on the different actuating signals, wheel-specific torques are applied to the road wheels 16 of the vehicle 10 so that, due to the torque difference between the road wheels 16, a yaw moment is induced, which brings about an indirect rotation of the vehicle 10 about the vehicle vertical axis. Based on the different actuating signals to the drive units 19 and/or deceleration devices 20 and, alternatively or additionally, to the rear wheel steering 15B, an indirect rotation of the vehicle 10 about the vehicle vertical axis may, therefore, be induced. As a result, indirect lateral control of the vehicle 10 is enabled with the use of TLC.

In operation S3 of the instructions and/or operations 50, at least one steering angle of a road wheel 16, in particular a steerable road wheel 16, is recorded via an additional sensor 30 of the auxiliary steering system 12. The additional sensor 30 is associated with the road wheel 16 and forwards the recorded steering angle to the control device 40 of the auxiliary steering system 12. Alternatively, the recording of measured values based on the additional sensor 30 may also be such that the steering angle is ascertained indirectly from the recorded measured values by, for example, the control device 40 or the sensor logic circuit 34.

Based on recording the measured values corresponding to the steering angle of the steerable road wheels in operation S3, the control of the auxiliary steering system 12 is, of course, adapted accordingly to comply with the steering inputs. In such examples, operation S3 leads back to step S2.

The instructions and/or operations 50 may be implemented (operation S3A) in that, when recording the steering angle of the at least one road wheel 16 based on the additional sensor 30, a relative angular position or an absolute angular position of the road wheel 16 is recorded by the additional sensor 30 and forwarded to the control device 40 of the auxiliary steering system 12. This means that the additional sensor 30 does not necessarily have to be configured to record an absolute value of a measured variable. It is also sufficient to record a relative value corresponding to a measured variable to operate the TLC (e.g., the auxiliary steering system 12) if an absolute value of the steering angle can be ascertained based on the relative value.

In addition, the instructions and/or operations 50 may also be implemented so that the control device 40 of the auxiliary steering system 12 takes into account a reference angle value for the road wheel 16. It may, therefore, be sufficient for the additional sensor 30 to simply record a relative value of the steering angle or a corresponding variable. The reference angle value may correspond to, for example, a zero position of the steerable road wheel 16 (e.g., a straight-ahead position). The reference angle value may have already been received by the electronic steering system 14 before the unexpected operating condition of the electronic steering system 14 was recorded.

The instructions and/or operations 50 disclosed herein advantageously enable a high level of precision of the auxiliary steering system 12 (TLC) since, based on the separate additional sensor 30, it may be ensured that an unexpected operating condition in the conventional, electronic steering system 14 cannot propagate into the auxiliary steering system 12. Consequently, the measured-value data, which are recorded based on the separate additional sensor 30 and provided for the auxiliary steering system 12, cannot be corrupted by the unexpected operating condition in the electronic steering system 14. Moreover, as a result of the instructions and/or operations 50, complex estimation methods for estimating the steering angle of road wheels 16 of the vehicle 10 can be avoided. The instructions and/or operations 50 are, therefore, particularly compact. In addition, by avoiding complex estimation methods, short control intervals may be ensured so that the reaction time of the auxiliary steering system 12 to steering inputs via the steering wheel 22 of the vehicle 10 is particularly short. The functionality of the control device 40 of the auxiliary steering system 12 may be executed by a superordinate driving control device 44 which is provided in the vehicle 10, so that torque control corresponding to the road wheels 16, which is provided in the vehicle control device 44, may also be used for the auxiliary steering system 12. The compactness (e.g., efficiency) of the instructions and/or operations 50 is therefore further increased.

Some examples disclosed here use switching circuits (e.g., one or more switching circuits) to implement standards, protocols, methods or technologies disclosed here, to functionally couple two or more components, to generate information, to process information, to analyze information, to generate signals, to code/decode signals, to convert signals, to transmit and/or to receive signals, to control other devices, etc. Circuits of any type may be used.

In some examples, a circuit, like the feedback control device, comprises, inter alia, one or more data processing devices, such as a processor (e.g., a microprocessor), a central processing unit (CPU), a digital signal processor (DSP), an application-specific integrated circuit (ASIC), a field-programmable gate array (FPGA), a system on a chip (SoC) or the like, or any combinations thereof, and may comprise discrete digital or analog circuit elements or electronics or combinations thereof. In some examples, the circuit comprises hardware circuit implementations (e.g., implementations in analog circuits, implementations in digital circuits and the like, and combinations thereof).

In some examples, switching circuits comprise combinations of switching circuits and computer program products with software or firmware commands which are stored on one or more computer-readable memories and cooperate to prompt a device to execute one or more of the protocols, methods or technologies described herein. In some examples, the circuit technology comprises switching circuits, such as microprocessors or parts of microprocessors, which require software, firmware and the like in order to operate. In some examples, the switching circuits comprise one or more processors or parts thereof and the associated software, firmware, hardware and the like.

The example instructions and/or operations 50 of FIG. 6 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, a hard disk drive (HDD), a flash memory, a read-only memory (ROM), a compact disc (CD), a digital versatile disc (DVD), a cache, a random-access memory (RAM) of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random-access memory of any type, read-only memory of any type, solid-state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

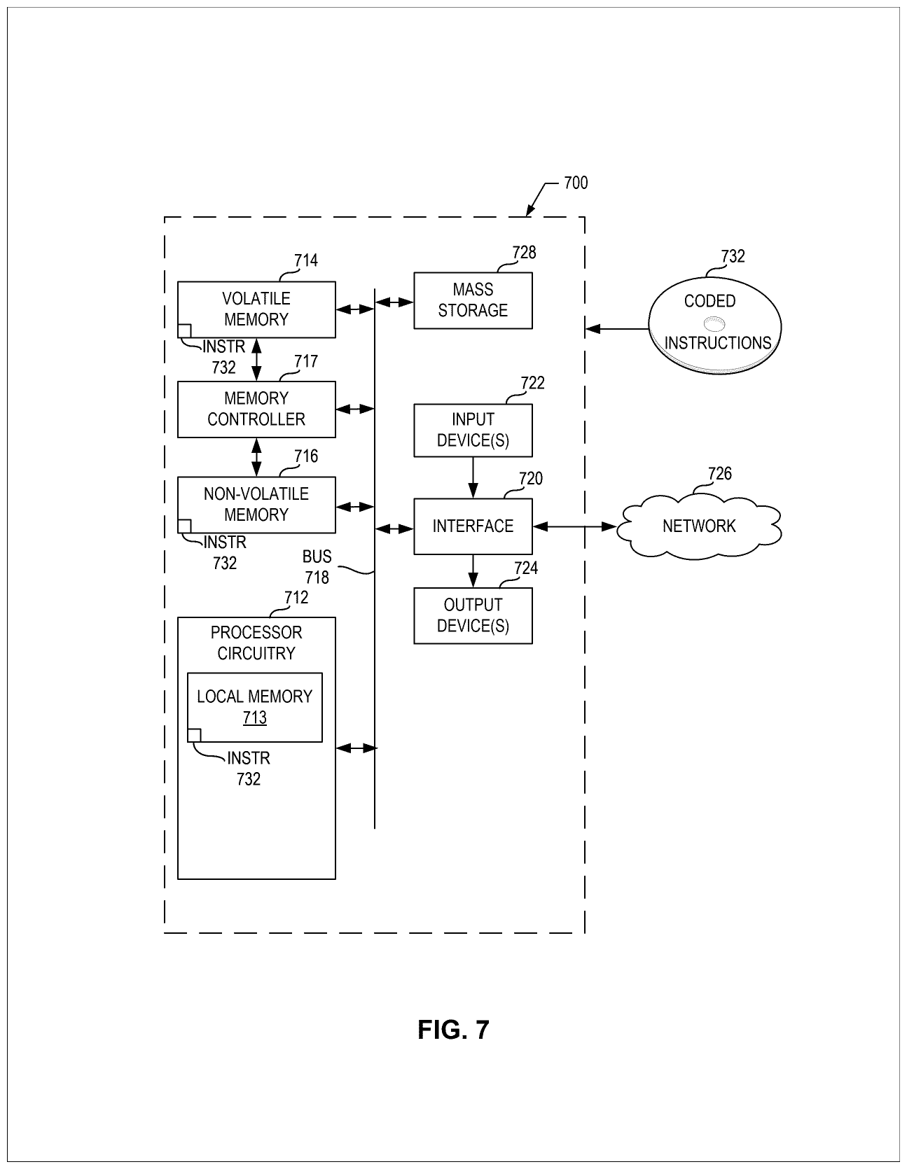

FIG. 7 is a block diagram of an example programmable circuitry platform 700 structured to execute and/or instantiate the example machine-readable instructions and/or the example operations of FIG. 6 to implement examples disclosed herein. The programmable circuitry platform 700 can be, for example, a control device, an ECU, a self-learning machine (e.g., a neural network), or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAS, microprocessors, CPUs, graphics processor units (GPUs), vision processor units (VPUs), DSPs, and/or microcontrollers from any desired family or manufacturer. The programmable circuitry 712 may be implemented by one or more semiconductor based (e.g., silicon based) devices.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as a controller area network (CAN), an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a button, a touchscreen, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), an in-place switching (IPS) display, a touchscreen, etc.), a tactile output device, and/or speaker. The interface circuitry 720 of the illustrated example, thus, typically includes a graphics driver card, a graphics driver chip, and/or graphics processor circuitry such as a graphics processor unit (GPU).

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or solid-state drives (SSDs).

The machine-readable instructions 732, which may be implemented by the machine-readable instructions of FIG. 6, may be stored in the mass storage device 728, in the volatile memory 714, in the non-volatile memory 716, and/or on at least one non-transitory computer readable storage medium such as a CD or DVD which may be removable.

Example methods, apparatus, systems, and articles of manufacture to provide auxiliary steering of a vehicle are disclosed herein. Further examples and combinations thereof include the following:

Example 1 includes a method comprising detecting a limited operating condition in an electronic steering system of a vehicle, the vehicle including front axle steering and rear axle steering, determining which of the front axle steering or the rear axle steering is associated with the limited operating condition, activating an auxiliary steering system based on at least one of drive units or deceleration devices corresponding to the one of the front axle steering or the rear axle steering associated with the limited operating condition to implement lateral control of the vehicle based on torque control via different wheel-specific torques of the at least one of the drive units or the deceleration devices, measuring a steering angle of a road wheel via a sensor of the auxiliary steering system, and providing the measured steering angle to a control device of the auxiliary steering system.

Example 2 includes any preceding clause(s) of example 1, wherein the sensor records a relative angular position or an absolute angular position of the road wheel and forwards the relative angular position or the absolute angular position to the control device of the auxiliary steering system.

Example 3 includes any preceding clause(s) of any one or more of examples 1-2, wherein the control device accesses a reference angle value corresponding to the road wheel.

Example 4 includes any preceding clause(s) of any one or more of examples 1-3, wherein the control device implements the lateral control of the vehicle based on the different wheel-specific torques corresponding to the one of the front axle steering or the rear axle steering associated with the limited operating condition and by setting an axle toe angle associated with the other one of the front axle steering or the rear axle steering.

Example 5 includes an auxiliary steering system for a vehicle, the auxiliary steering system comprising a control device, and at least one sensor associated with at least one of a plurality of road wheels of the vehicle and configured to record an angular position of the at least one road wheel and to forward the angular position to the control device, the control device to activate the auxiliary steering system in response to a limited operating condition in one of front axle steering or rear axle steering of the vehicle, and provide lateral control of the vehicle based on torque control and the angular position of the at least one road wheel by sending actuating signals to at least one of drive units or deceleration devices corresponding to the one of the front axle steering or the rear axle steering associated with the limited operating condition, the actuating signals to cause generation of wheel-specific torques at corresponding ones of the road wheels of the vehicle.

Example 6 includes any preceding clause(s) of example 5, wherein the control device is to provide the lateral control of the vehicle based on steering angles to control the one of the front axle steering or the rear axle steering not associated with the limited operating condition.

Example 7 includes any preceding clause(s) of any one or more of examples 5-6, wherein the sensor is configured to record a relative angular position as the angular position of the at least one road wheel.

Example 8 includes any preceding clause(s) of any one or more of examples 5-7, wherein the sensor is to be selectively coupleable to different supply circuits.

Example 9 includes any preceding clause(s) of any one or more of examples 5-8, wherein the sensor includes a sensor element, a sensor logic circuit, a communication interface, and a supply connection.

Example 10 includes any preceding clause(s) of any one or more of examples 5-9, wherein the sensor is at least one of a pinion sensor to be coupled to a pinion tower, a linear sensor to be coupled to a steering rack of an electronic steering system, or a rotation sensor to be coupled to a ball screw nut of the electronic steering system.

Example 11 includes any preceding clause(s) of any one or more of examples 5-10, wherein the sensor is to be coupled to a driving control device of the vehicle, wherein the driving control device controls at least one of the drive units or the deceleration devices.

Example 12 includes any preceding clause(s) of any one or more of examples 5-11, wherein the control device is to provide the lateral control of the vehicle based on the wheel-specific torques and by setting an axle toe angle associated with one of the front axle steering or the rear axle steering not associated with the limited operating condition.

Example 13 includes a non-transitory machine-readable storage medium comprising instructions to cause programmable circuitry to at least obtain an angular position of a road wheel of a vehicle based on a measurement from a sensor, activate an auxiliary steering system in response to a limited operating condition associated with one of front axle steering or rear axle steering of the vehicle, and implement lateral control of the vehicle based on torque control and the angular position of the road wheel by generating an actuating signal to control at least one of a drive unit or a deceleration device corresponding to the one of the front axle steering or the rear axle steering associated with the limited operating condition, the actuating signal to cause generation of a wheel-specific torque at the road wheel.

Example 14 includes any preceding clause(s) of example 13, wherein the instructions are to cause the programmable circuitry to implement the lateral control of the vehicle based on steering angles to control the one of the front axle steering or the rear axle steering not associated with the limited operating condition.

Example 15 includes any preceding clause(s) of any one or more of examples 13-14, wherein the instructions are to cause the programmable circuitry to obtain an absolute angular position as the angular position of the road wheel.

Example 16 includes any preceding clause(s) of any one or more of examples 13-15, wherein the instructions are to cause the programmable circuitry to implement the lateral control of the vehicle based on the wheel-specific torque and by setting an axle toe angle associated with the one of the front axle steering or the rear axle steering not associated with the limited operating condition.

Example 17 includes any preceding clause(s) of any one or more of examples 13-16, wherein the instructions are to cause the programmable circuitry to implement the lateral control of the vehicle based on steering inputs.

Example 18 includes any preceding clause(s) of any one or more of examples 13-17, wherein the measurement from the sensor is a relative angular position, the instructions are to cause the programmable circuitry to determine the angular position of the road wheel based on the relative angular position and a reference angle value.

Example 19 includes any preceding clause(s) of any one or more of examples 13-18, wherein the programmable circuitry is a first control device of the vehicle, wherein power to the programmable circuitry is controlled by a second control device of the vehicle.

Example 20 includes any preceding clause(s) of any one or more of examples 13-19, wherein the measurement from the sensor is feedback during the lateral control of the vehicle.

In this disclosure, reference may be made to quantities and numbers. Unless explicitly stated, such quantities and numbers should not be regarded as limiting but as examples of the possible quantities or numbers with regard to the disclosure. In this regard, in the present disclosure, the term “multiplicity” may also be used to refer to a quantity or number. In this regard, the term “multiplicity” means any number which is greater than one, e.g., two, three, four, five, etc. The terms “for instance”, “approximately”, “close to”, etc. mean plus or minus 5% of the specified value.

Although the disclosure has been illustrated and described with reference to one or more examples, a person skilled in the art, after reading and understanding this description and the accompanying drawings, will be able to make equivalent changes and modifications.

What is claimed is:

1. A method comprising:
detecting a limited operating condition in an electronic steering system of a vehicle, the vehicle including front axle steering and rear axle steering;
determining which of the front axle steering or the rear axle steering is associated with the limited operating condition;
activating an auxiliary steering system based on at least one of drive units or deceleration devices corresponding to the one of the front axle steering or the rear axle steering associated with the limited operating condition to implement lateral control of the vehicle based on torque control via different wheel-specific torques of the at least one of the drive units or the deceleration devices;
measuring a steering angle of a road wheel via a sensor of the auxiliary steering system; and
providing the measured steering angle to a control device of the auxiliary steering system.

2. The method of claim 1, wherein the sensor records a relative angular position or an absolute angular position of the road wheel and forwards the relative angular position or the absolute angular position to the control device of the auxiliary steering system.

3. The method of claim 2, wherein the control device accesses a reference angle value corresponding to the road wheel.

4. The method of claim 1, wherein the control device implements the lateral control of the vehicle based on the different wheel-specific torques corresponding to the one of the front axle steering or the rear axle steering associated with the limited operating condition and by setting an axle toe angle associated with the other one of the front axle steering or the rear axle steering.

5. An auxiliary steering system for a vehicle, the auxiliary steering system comprising:
a control device; and
at least one sensor associated with at least one of a plurality of road wheels of the vehicle and configured to record an angular position of the at least one road wheel and to forward the angular position to the control device, the control device to:
activate the auxiliary steering system in response to a limited operating condition in one of front axle steering or rear axle steering of the vehicle; and
provide lateral control of the vehicle based on torque control and the angular position of the at least one road wheel by sending actuating signals to at least one of drive units or deceleration devices corresponding to the one of the front axle steering or the rear axle steering associated with the limited operating condition, the actuating signals to cause generation of wheel-specific torques at corresponding ones of the road wheels of the vehicle.

6. The auxiliary steering system of claim 5, wherein the control device is to provide the lateral control of the vehicle based on steering angles to control the one of the front axle steering or the rear axle steering not associated with the limited operating condition.

7. The auxiliary steering system of claim 5, wherein the sensor is configured to record a relative angular position as the angular position of the at least one road wheel.

8. The auxiliary steering system of claim 5, wherein the sensor is to be selectively coupleable to different supply circuits.

9. The auxiliary steering system of claim 5, wherein the sensor includes a sensor element, a sensor logic circuit, a communication interface, and a supply connection.

10. The auxiliary steering system of claim 5, wherein the sensor is at least one of a pinion sensor to be coupled to a pinion tower, a linear sensor to be coupled to a steering rack of an electronic steering system, or a rotation sensor to be coupled to a ball screw nut of the electronic steering system.

11. The auxiliary steering system of claim 5, wherein the sensor is to be coupled to a driving control device of the vehicle, wherein the driving control device controls at least one of the drive units or the deceleration devices.

12. The auxiliary steering system of claim 5, wherein the control device is to provide the lateral control of the vehicle based on the wheel-specific torques and by setting an axle toe angle associated with the one of the front axle steering or the rear axle steering not associated with the limited operating condition.

13. A non-transitory machine-readable storage medium comprising instructions to cause programmable circuitry to at least:
obtain an angular position of a road wheel of a vehicle based on a measurement from a sensor;
activate an auxiliary steering system in response to a limited operating condition associated with one of front axle steering or rear axle steering of the vehicle; and
implement lateral control of the vehicle based on torque control and the angular position of the road wheel by generating an actuating signal to control at least one of a drive unit or a deceleration device corresponding to the one of the front axle steering or the rear axle steering associated with the limited operating condition, the actuating signal to cause generation of a wheel-specific torque at the road wheel.

14. The non-transitory machine-readable storage medium of claim 13, wherein the instructions are to cause the programmable circuitry to implement the lateral control of the vehicle based on steering angles to control the one of the front axle steering or the rear axle steering not associated with the limited operating condition.

15. The non-transitory machine-readable storage medium of claim 13, wherein the instructions are to cause the programmable circuitry to obtain an absolute angular position as the angular position of the road wheel.

16. The non-transitory machine-readable storage medium of claim 13, wherein the instructions are to cause the programmable circuitry to implement the lateral control of the vehicle based on the wheel-specific torque and by setting an axle toe angle associated with the one of the front axle steering or the rear axle steering not associated with the limited operating condition.

17. The non-transitory machine-readable storage medium of claim 13, wherein the instructions are to cause the programmable circuitry to implement the lateral control of the vehicle based on steering inputs.

18. The non-transitory machine-readable storage medium of claim 13, wherein the measurement from the sensor is a relative angular position, the instructions are to cause the programmable circuitry to determine the angular position of the road wheel based on the relative angular position and a reference angle value.

19. The non-transitory machine-readable storage medium of claim 13, wherein the programmable circuitry is a first control device of the vehicle, wherein power to the programmable circuitry is controlled by a second control device of the vehicle.

20. The non-transitory machine-readable storage medium of claim 13, wherein the measurement from the sensor is feedback during the lateral control of the vehicle.
